(19) United States
(12) Patent Application Publication
(10) Pub. No.: US 2006/0282353 A1
(43) Pub. Date: Dec. 14, 2006

(54) OBJECT ORIENTED VISUAL ACCOUNTING SYSTEM

(76) Inventor: David Cameron Gikandi, Broadbeach (AU)

Correspondence Address: DAVID CAMERON GIKANDI, 15 ALBERT AVENUE, SUITE 292, BROADBEACH, 4218, AU

(21) Appl. No.: 11/308,014

(22) Filed: Mar. 3, 2006

Related U.S. Application Data
(60) Provisional application No. 60/679,765, filed on May 11, 2005.

(51) Int. Cl. G07B 17/00

(52) U.S. Cl. 705/30

(57) ABSTRACT

An object oriented visual accounting system that enables accounting tasks to be handled in the same way that they work in real life. Each entity (object), such as a person, mortgage or other asset or liability, is represented by a self-contained MoneyCell. The MoneyCell is dropped onto a stream of cash and it then interacts with this cash by intelligently adding to the cash or taking cash away from the cash stream if and when needed. In this way, the invention makes it much easier for the lay person to accomplish accounting tasks, and for anyone to instantly see the effects of any transaction on wealth and cash flow in the past and future in perpetuity. An object of this invention is to simplify accounting, make it more powerful as a forecasting and planning tool, while simultaneously making it more congruent with reality.

### RELATED APPLICATIONS

The present application is a continuation-in-part application of U.S. provisional patent application Ser. No. 60/679,765, filed May 11, 2005, for WHOLE HAND COMPUTER MOUSE WITH A BUTTON FOR EACH FINGER, by David Cameron Gikandi, included by reference herein and for which benefit of the priority date is hereby claimed.

### FIELD OF THE INVENTION

The present invention relates to accounting and finance software and principles and more particularly pertains to a new object oriented visual accounting system that both integrates with current accounting principles and software but also goes ahead and enables accounting tasks to be handled in the same way that they work in real life.

### BACKGROUND OF THE INVENTION

Ever since people started using money, they have found a need to keep an accurate record of it, to make such record keeping simple, and to be able to see into their financial future so that they can plan their lives accordingly.

However, up until now, doing the above has required schooling in the field of accounting, and vast amounts of time to perform accounting procedures, what-if analysis and forecasting. In fact, such things are out of the reach of most people. Most people take on debts, make investments, and so on, and they are completely blind as to what the effect of those actions will be on their cash flow and net worth in the future in perpetuity. They only get to know of a problem (such as running out of money or having too many commitments) when it has already happened, rather than way before it happens so that they may have a chance to avoid it.

There is a big need, on all levels of accounting and finance, for an easier way to account and forecast, a way that reflects real life as accurately as possible, in perpetuity.

The current accounting system used today, double-entry book keeping, was invented in the medieval commercial city-states of Italy from around 1340 AD. Since then, a lot has changed in the real world, including the advent and popularity of computers and the increased complexity of financial objects such as investments and annuities. However, the accounting system has not changed much to reflect these changes. Additionally, it never really represented money as it flows in real life in real-time. Today, we have many software based accounting packages and systems, but they all are based on double-entry accounting and all they do is simplify the use of double-entry accounting without making any fundamental changes in the way accounting is viewed and handled.

The biggest disadvantage of previous accounting principles is that they follow an unnatural process. In real life, transactions happen naturally between entities, and each transaction has an effect on the overall cash flow and wealth, now and in perpetuity. The double-entry system is static and is unable to reflect these changes in a way that reflects how things work in real life. The current accounting standards and principles do not instantly reflect back to the person what the effect of a transaction is on the wealth and cash flow of the whole system (such as a business or person). The double-entry system is also abstract.

There is a large learning curve that requires a person to school himself or herself in accounting before they can perform accounting tasks for their personal finances or business.

Making what-if analysis and forecasting is difficult and static, unable to instantly show the results of proposed transactions on the worth and cash position for any date in perpetuity.

The current accounting systems do not work in the same way a human mind works and in the way that money flows in real life (current accounting methods and systems are static or abstracted).

Because of their design, current accounting systems are highly error-prone as well. And because of the amount of time needed to perform accounting tasks, efficiency is compromised and reporting is past-based since reports are compiled several days or months after the fact.

It is therefore an object of the invention to simplify accounting, make it more powerful as a forecasting and planning tool, while simultaneously making it more congruent with reality.

It is another object of the invention to eliminate the need for end user to understand details of a complex object such as an annuity, perpetual insurance plan, or mortgage. The inner workings of any object are handled by the MoneyCell representing it.

It is another object of the invention to make it easy to do what-if analysis and forecasting.

It is another object of the invention to make accounting timeline-based and perpetual, just like real life is.

It is another object of the invention to show instantly what the effect of any transaction is on actual cash flow and net worth.

It is another object of the invention to eliminate the lag between having a transaction and seeing the effects of that transaction on cash flow and wealth in the future and in perpetuity.

It is another object of the invention to bring to the field of accounting the concepts of encapsulation and object-orientation that are found in modern software languages such as Visual Basic .NET and other object-oriented programming languages.

It is another object of the invention to make accounting work in the same way a human mind works and in the way that money flows in real life (current accounting methods and systems are static or abstracted).

It is another object of the invention to make accounting visual and easy to use.

It is another object of the invention to make accounting easy to understand by anyone, even those not trained in accounting principles.

It is another object of the invention to integrate this new way of accounting with current accounting standards to ensure interoperability.

It is another object of the invention to vastly reduce accounting errors because each MoneyCell is pre-programmed and tested by a professional and then rolled out to as many users as need it, hence ensuring error-free operation.

It is another object of the invention to increase efficiency in the accounting field.

Still further objects and advantages will become apparent from a consideration of the ensuing descriptions and drawings.

### SUMMARY OF THE INVENTION

In accordance with the present invention, there is provided an object oriented visual accounting system that enables accounting tasks to be handled in the same way that they work in real life. Each entity (object), such as a person, mortgage or other asset or liability, is represented by a self-contained MoneyCell. The MoneyCell is dropped onto a stream of cash and it then interacts with this cash by intelligently adding to the cash or taking cash away from the cash stream if and when needed. In this way, the invention makes it much easier for the layperson to accomplish accounting tasks, and for anyone to instantly see the effects of any transaction on wealth and cash flow in the past and future in perpetuity.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of a main screen in accordance with the invention, showing a few sample MoneyCells (car, house, wages, fees and stocks) that have been dropped into a cash “river” at various points in a timeline. it also shows a chart showing the wealth and cash amounts along that timeline;

FIG. 2 is a front view of a full screen that includes the main screen in FIG. 1, a list of MoneyCells and a properties sheet for the selected MoneyCell; and

FIG. 3 is a front view of a MoneyCell, which is the building block of this whole invention. The MoneyCell is an object. By definition, an object is an entity in the same way that a person or a car is an entity, complete in itself. The methods, properties and events of an entity (object) are encapsulated within the entity. An object can be treated as a complete, independent unit. An object can be an asset, a liability, an entire business, a mortgage, a person, in fact, just about anything. The MoneyCell lets you declare variables, events, properties, methods and procedures of the entity once and then reuse them whenever needed. Although we call it a MoneyCell here, it can be called by any other name.

For purposes of clarity and brevity, like elements and components will bear the same designations and numbering throughout the Figures.

### DESCRIPTION OF THE PREFERRED EMBODIMENT

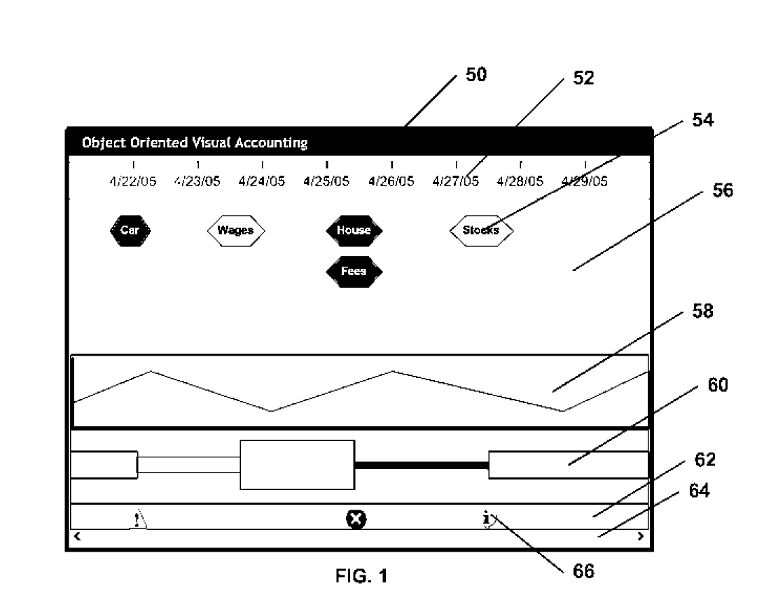

FIG. 1 is a front view of a Main Screen 50 in accordance with the invention, showing a few sample financial entities (MoneyCell Object 54) that have been dropped into a Cash Stream 56 at various points in a timeline 52. It also shows charts showing the wealth (wealth/value chart 58) and cash amounts (cash flow chart 60) along that timeline 52. A user can scroll left or right along the timeline 52 using the Scroller 64 at the bottom. They can scroll forwards into time into perpetuity or backwards, seeing how their financial position looks like in an instant. It also shows an Alerts Bar 62 that, whenever necessary, displays alert icons 66. An alert icon would be shown whenever the user needs to know something crucial about the cash flow or perhaps a message from a MoneyCell Object 54 such as a reminder to carry out a particular action.

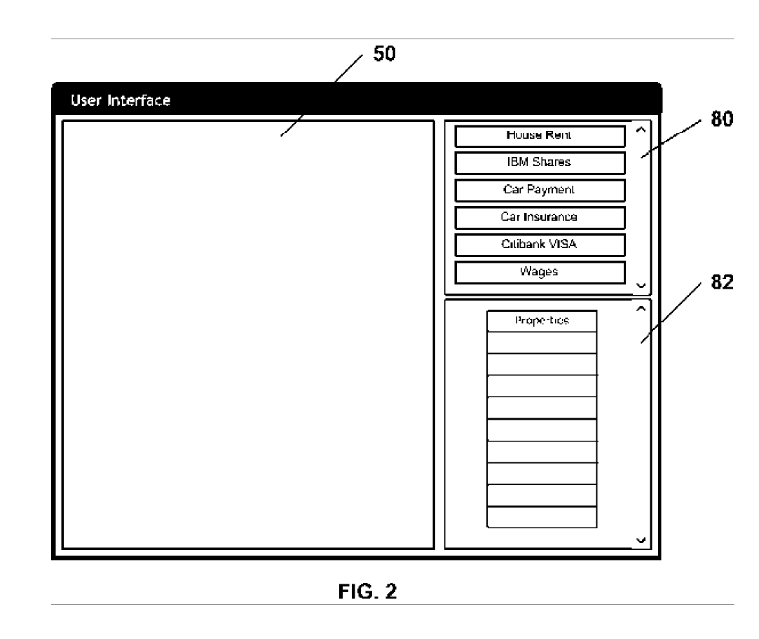

FIG. 2 is a front view of a full screen that includes the Main Screen 50 in FIG. 1, a list of MoneyCells and a properties sheet for the selected MoneyCell Object 54. A user can select a MoneyCell Object 54 from the Entities List 80 and configure its properties in the Entity Properties Sheet 82. They can then drag and drop it anywhere on the cash stream 56 where it automatically starts to interact with the stream by adding cash to it or removing cash from it as needed and dictated in the MoneyCell's properties. A MoneyCell Object 54 knows, from its programming, when and how to take money in or out of the stream, at which points in the stream it should appear once placed by the user, and when to stop being active (e.g. when all payments have been made). Therefore, by scrolling forward in time on the Main Screen 50, a user can visually and instantly predict, for example, at what points in time they may run short of money due to various demands on from the MoneyCells, or perhaps see the effect 20 years down the line of an annuity or investment MoneyCell Object 54, or even see the tax effect of adding various asset or liability MoneyCells several years from now. This gives them ample time to plan and prepare, since they have an insight into the future.

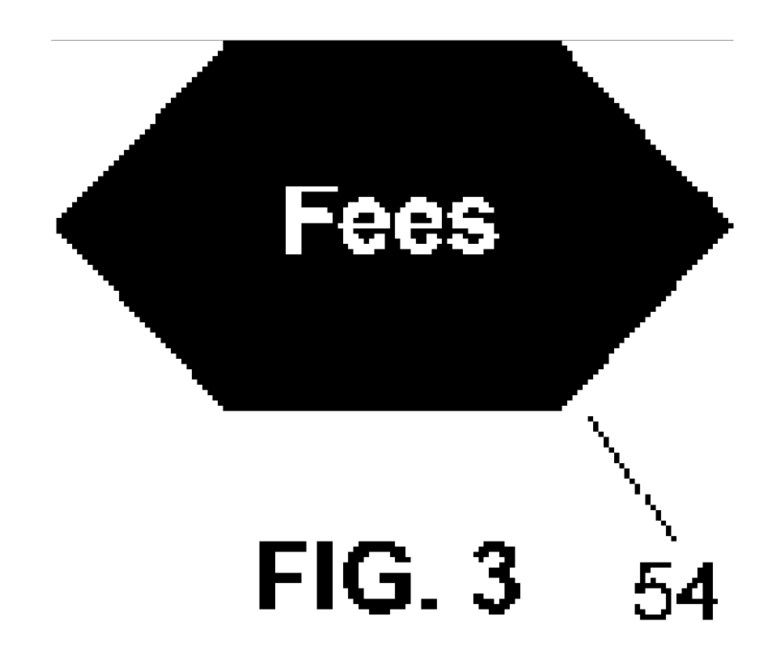

FIG. 3 is a front view of a MoneyCell Object 54, which is the building block of this whole invention. A MoneyCell Object 54 can be designed for any entity or task (e.g. rents, mortgage, wages, fees, investments, tax). The MoneyCell Object 54 is an object. By definition, an object is an entity in the same way that a person or a car is an entity, complete in itself. The methods, properties and events of an entity (object) are encapsulated within the entity. An object can be treated as a complete, independent unit. An object can be an asset, a liability, an entire business, a mortgage, a person, in fact, just about anything. The MoneyCell Object 54 lets you declare variables, events, properties, methods and procedures of the entity once and then reuse them whenever needed. Although we call it a MoneyCell Object 54 here, it can be called by any other name.

In Operation:

To understand the new invention, one must first understand the MoneyCell Object 54, the core of this invention. The MoneyCell Object 54 is a self-contained entity (object) that knows how to interact with the cash stream 56. A MoneyCell Object 54 can be simple, such as an income MoneyCell Object 54 which simply adds a fixed amount of cash into the stream every week, representing a user's weekly earnings on the job. It can also be complex, for example representing a stock option transaction.

Regardless of its simplicity or complexity, it exposes the following to the cash stream 56:

(1) Cash In or Out Amount & Date (this adds to or reduces from the stream and is reflected on the cash flow chart 60)

(2) Worth/Value of the MoneyCell Object 54 (this adds to or reduces from the stream and is reflected on the wealth/value chart 58)

(3) Information and notifications (these appear on the Alerts Bar 62 or anywhere else depending on how the user interface is designed)

Everything else regarding the entity is handled internally in the MoneyCell Object 54. In this way, the MoneyCell Object 54 is a self-contained encapsulated system that only demands to be fed a certain amount of cash at a certain date(s) or gives out a certain amount of cash on a certain date(s), all as determined by the internal programming of the MoneyCell Object 54.

The key to this invention is the way the MoneyCell Object 54 works: a self-contained encapsulated system that only demands to be fed a certain amount of cash at a certain date(s) or gives out a certain amount of cash on a certain date(s), all as determined by the internal programming of the MoneyCell Object 54. It automatically takes cash in from or out to the cash stream 56 when it needs to.

The internal programming of a MoneyCell Object 54 is what gives it the methods, events and properties, and rules, by which the MoneyCell Object 54 operates. This programming can be done by anyone, such as the provider of an insurance policy (whereby the user then downloads the MoneyCell Object 54 from the insurance company's web site and adds it to their Entities List 80 for use). Some standard MoneyCells such as wages, rent and car payments MoneyCells, can ship with the software package.

Each MoneyCell Object 54 may need certain properties to be set by the user. For example, a rent MoneyCell Object 54 will require the user to set how much rent and how often they pay it. An insurance MoneyCell Object 54 will require the user to set what the premiums are and when they are required to be paid, and if their is a maturity, when and how much that is. On the user interface, the user accomplishes this by selecting the MoneyCell Object 54 from the Entities List 80 and setting the properties for the selected MoneyCell Object 54 in the Entity Properties Sheet 82. They can then drag and drop the MoneyCell Object 54 onto the cash stream 56 and it will start interacting with the stream automatically, adding or removing money from the stream at the programmed dates. The MoneyCell Object 54 will also duplicate itself as dictated by its internal programming/rules (for example, a rent MoneyCell Object 54 will automatically repeat itself every week if the user pays rent every week, placing itself on the timeline 52 every Friday, for example).

On the back end, this invention is meant to integrate with current accounting standards so that it is able to produce balance sheets, income statements, and other such standard accounting reports. In fact, the user can view their accounts using the screen as shown in FIG. 1, or they can elect to view them using the normal accounting static sheets view. This invention eliminates the need for the user to record items in a journal, post them to a ledger, and then work them out onto a trial balance and onto a balance and income statement. However, it will do that in the background anyway if the user requires it to.

This invention is not only for personal finance. It can also be used for corporate finance and accounting, transnational finance and accounting, investment finance and accounting and practically anything that uses money on any scale.

This invention makes it very easy to do what-if analysis and forecasting. To do what-if analysis, a user would simply drag and drop a MoneyCell Object 54 onto the Cash Stream 56 and instantly see how that affects their cash flow and wealth position now and into the future in perpetuity. The timeline 52 allows the user to scroll as far into the future as they wish to see what their cash and wealth position would be at any point in time. In this way, they can quickly identify periods when they will need cash if the cash flow is negative, when they will have excess cash so that they can take advantage of investment opportunities, etc. For example, a real estate investor can do a quick what-if analysis and forecast to see what the effect of adding ten new buildings to their portfolio would be. They would simply drag and drop ten property MoneyCells onto the stream. Each of those cells would have everything preprogrammed in them, such as mortgage payment amounts and dates, rental income, etc. As soon as they are dropped onto the stream, the system would calculate their effect on the overall cash flow and wealth balance position now and in perpetuity, and all the investor would have to do is use the scroller 64 to scroll along the timeline 52 into the future to see the effect.

As you can see, this invention makes accounting work roughly in the same way a human mind works and also in the way that money flows in real life (as opposed to current accounting methods and systems which are static or abstracted). It also makes accounting visual and easy to use and understand by anyone, even those not trained in accounting principles.

It also vastly reduces accounting errors because each MoneyCell Object 54 is pre-programmed and tested by professionals and then rolled out to as many users as need it, hence ensuring error-free operation.

Efficiency in the accounting field is also greatly increased, especially when it comes to what-if analysis and forecasting.

Although the description above contains many specifics, these should not be construed as limiting the scope of this invention but as merely providing illustrations of some of the preferred embodiments of this invention. For example, the user interface can be completely redesigned in any one of a multitude of possible ways while still achieving said objectives. It can also be made part of a larger accounting package, and so on.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An object oriented visual accounting system for facilitating accounting that very closely mirrors how things work in real life, dynamically and perpetually, and making accounting, what-if analysis and forecasting easy, comprising:
means for displaying visual, timeline-based, perpetual accounting information that depicts entities, how they interact with each other financially, and their effect on cash flow and net worth in perpetuity;
means for encapsulating all the rules, methods, properties and events of a financial entity such as a person, business, rental property, salary, investment, or anything else that takes in or puts out cash;
means for indicating the date when each financial activity, position or statement is occurring and allowing the user to scroll back and forth into time in perpetuity to see what their financial position is at any point in time in the future or past;
means for providing an interactive area where the user can add or remove financial entities so that they can interact with the rest of the user's financial portfolio, cash flow and worth;
means for displaying the net worth position at any point in time; means for displaying the cash flow position at any point in time;
means for scrolling back and forth through time to allow the user to see their financial position in the past and into the future;
means for listing all available financial entities so that the user can modify them, add or remove them, or use them; and
means for modifying the rules, methods, properties and events of a financial entity.

2. The object oriented visual accounting system in accordance with claim 1, wherein said means for displaying visual, timeline-based, perpetual accounting information that depicts entities, how they interact with each other financially, and their effect on cash flow and net worth in perpetuity comprises a main screen.

3. The object oriented visual accounting system in accordance with claim 1, wherein said means for encapsulating all the rules, methods, properties and events of a financial entity such as a person, business, rental property, salary, investment, or anything else that takes in or puts out cash comprises a drag-and-droppable, programmable, interactive MoneyCell object.

4. The object oriented visual accounting system in accordance with claim 1, wherein said means for indicating the date when each financial activity, position or statement is occurring and allowing the user to scroll back and forth into time in perpetuity to see what their financial position is at any point in time in the future or past comprises a scrollable timeline.

5. The object oriented visual accounting system in accordance with claim 1, wherein said means for providing an interactive area where the user can add or remove financial entities so that they can interact with the rest of the user's financial portfolio, cash flow and worth comprises a cash stream.

6. The object oriented visual accounting system in accordance with claim 1, wherein said means for displaying the net worth position at any point in time comprises a wealth/value chart.

7. The object oriented visual accounting system in accordance with claim 1, wherein said means for displaying the cash flow position at any point in time comprises a cash flow chart.

8. The object oriented visual accounting system in accordance with claim 1, wherein said means for scrolling back and forth through time to allow the user to see their financial position in the past and into the future comprises a scroller.

9. The object oriented visual accounting system in accordance with claim 1, wherein said means for listing all available financial entities so that the user can modify them, add or remove them, or use them comprises an entities list.

10. The object oriented visual accounting system in accordance with claim 1, wherein said means for modifying the rules, methods, properties and events of a financial entity comprises an entity properties sheet.

11. An object oriented visual accounting system for facilitating accounting that very closely mirrors how things work in real life, dynamically and perpetually, and making accounting, what-if analysis and forecasting easy, comprising:
a main screen, for displaying visual, timeline-based, perpetual accounting information that depicts entities, how they interact with each other financially, and their effect on cash flow and net worth in perpetuity;
a drag-and-droppable, programmable, interactive MoneyCell object, for encapsulating all the rules, methods, properties and events of a financial entity such as a person, business, rental property, salary, investment, or anything else that takes in or puts out cash;
a scrollable timeline, for indicating the date when each financial activity, position or statement is occurring and allowing the user to scroll back and forth into time in perpetuity to see what their financial position is at any point in time in the future or past;
a cash stream, for providing an interactive area where the user can add or remove financial entities so that they can interact with the rest of the user's financial portfolio, cash flow and worth;
a wealth/value chart, for displaying the net worth position at any point in time;
a cash flow chart, for displaying the cash flow position at any point in time;
a scroller, for scrolling back and forth through time to allow the user to see their financial position in the past and into the future;
an entities list, for listing all available financial entities so that the user can modify them, add or remove them, or use them; and
an entity properties sheet, for modifying the rules, methods, properties and events of a financial entity.
